(19) United States
(12) Patent Application Publication
(10) Pub. No.: US 2014/0301159 A1
(43) Pub. Date: Oct. 9, 2014

(54) METHOD FOR DETERMINING A STATE OF AN ULTRASOUND PROBE

(71) Applicants: QISDA CORPORATION, Taoyuan County (TW); QISDA (SUZHOU) CO., Ltd., Suzhou (CN)

(72) Inventor: Tang-Chen Chang, Hsinchu County (TW)

(73) Assignees: QISDA CORPORATION, Taoyuan County (TW); QISDA (SUZHOU) CO., Ltd., Suzhou (CN)

(21) Appl. No.: 14/248,358

(22) Filed: Apr. 9, 2014

(30) Foreign Application Priority Data
Apr. 9, 2013 (TW) 102112482

(51) Int. Cl. G01S 15/02

(52) U.S. Cl. CPC G01S 15/02
USPC 367/7

(57) ABSTRACT

A method for determining whether an ultrasound probe is on a scan state or on a non-scan state includes the following steps. An object is scanned to generate an image by the ultrasound probe, and the image is divided into a strong echo area and a weak echo area. The ultrasound probe is determined to be on the scan state as a signal intensity in the weak echo area of the image is greater than a threshold. Otherwise, the ultrasound probe is determined to be on the non-scan state as the signal intensity in the weak echo area of the image is less than the threshold, and the ultrasound probe enters a freeze mode so as to store a frozen image at a time before entering the freeze mode.

### BACKGROUND OF THE INVENTION

1. Field of the Invention

The present invention relates to a method for determining a state of an ultrasound probe, and more specifically, to a method for determining whether an ultrasound probe is on a scan state or on a non-scan state.

2. Description of the Prior Art

An ultrasound scanner is generally used in a nondestructive test, and the ultrasound scanner emits ultrasound signals and receives the echo ultrasound signals of the reflected by objects for detection. An ultrasound probe of the ultrasound scanner includes precise ultrasound elements for detecting signal intensity. However, the ultrasound elements will wear after being used for a long time, so that parameters of the ultrasound elements must be calibrated to meet the requirements of ultrasound detection. Besides, as the ultrasound probe is not in use, the ultrasound scanner cannot shut down automatically to stop emitting ultrasound signals, and it causes decrease of the service life of the ultrasound probe. Therefore, it is an important issue to set a freeze mode for stopping the ultrasound probe from emitting ultrasound signals as the ultrasound probe is not in use, so as to save power and prolong the service life of the ultrasound probe.

### SUMMARY OF THE INVENTION

The present invention is to provide a method for determining whether an ultrasound probe is on a scan state or on a non-scan state.

According to the disclosure, a method for determining whether an ultrasound probe is on a scan state or on a non-scan state includes the following steps. An ultrasound probe emits ultrasound signals for scanning and generating an image, and the image is divided into a strong echo area and a weak echo area. The ultrasound probe is determined to be on the scan state as a signal intensity in the weak echo area of the image is greater than a threshold. Otherwise, the ultrasound probe is determined to be on the non-scan state as the signal intensity in the weak echo area of the image is less than the threshold, and the ultrasound probe entering a freeze mode so as to store a frozen image at a time before entering the freeze mode.

According to the disclosure, another method of saving power of the ultrasound probe includes scanning to generate an image by ultrasound signals emitted from the ultrasound probe, dividing the image into a strong echo area and a weak echo area, and stopping the ultrasound probe from emitting ultrasound signals as the signal intensity in the weak echo area of the image is less than a threshold for a predetermined period.

The method of the present invention includes determining whether the ultrasound probe is on the scan state or on the non-scan state. If the ultrasound probe is on the non-scan state and not in use for a long period, the ultrasound probe can enter the freeze mode and stop emitting ultrasound signals, so as to save power and reduce wear of the ultrasound probe. Furthermore, the freeze mode of the ultrasound probe can be canceled for restarting to scan.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a standard image generated by an ultrasound probe and displayed on a user interface according to an embodiment of the present invention.

FIG. 2 is a diagram of a signal intensity distribution of scan lines of the standard image for generating a critical intensity value according to the embodiment of the present invention.

FIG. 3 is a diagram of dividing the standard image into a strong echo area and a weak echo area by the critical intensity value according to the embodiment of the present invention.

FIG. 4 is a flow chart of a method for determining whether the ultrasound probe is on a scan state or on a non-scan state according to the embodiment of the present invention.

FIG. 5 is a diagram of signal intensity average values corresponding to different depths of the image and the standard image in different conditions according to the embodiment of the present invention.

### DETAILED DESCRIPTION

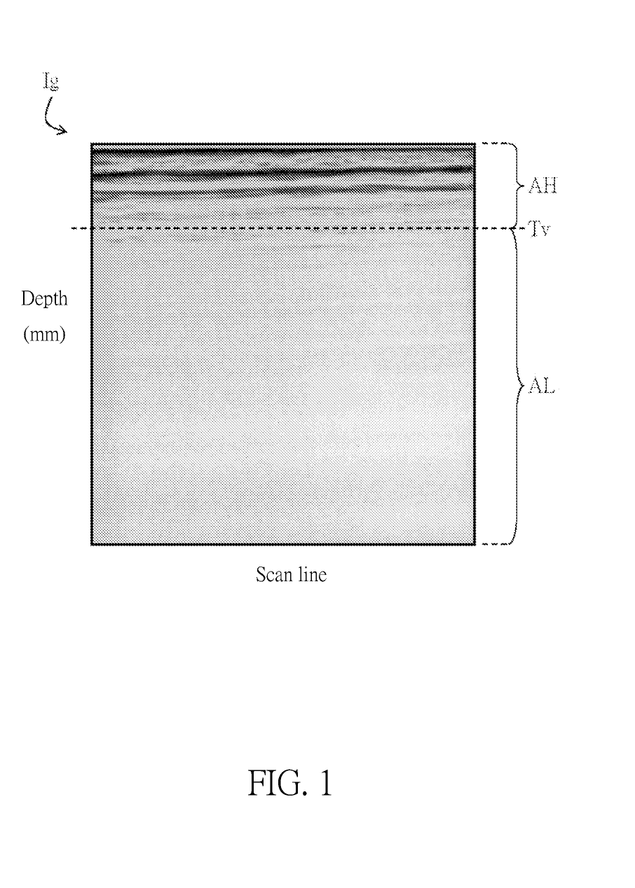

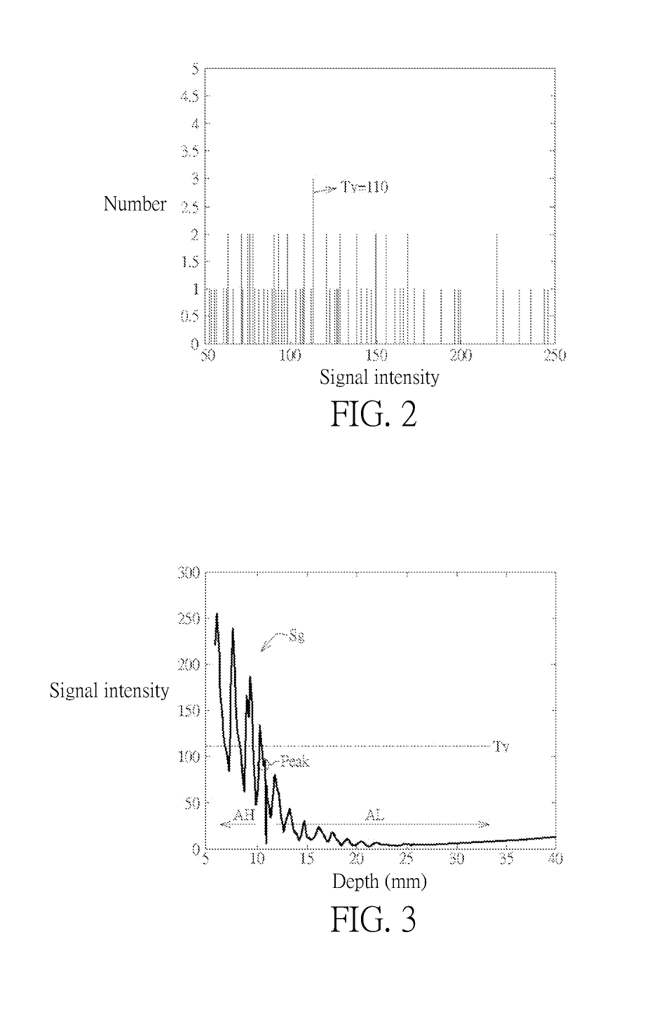

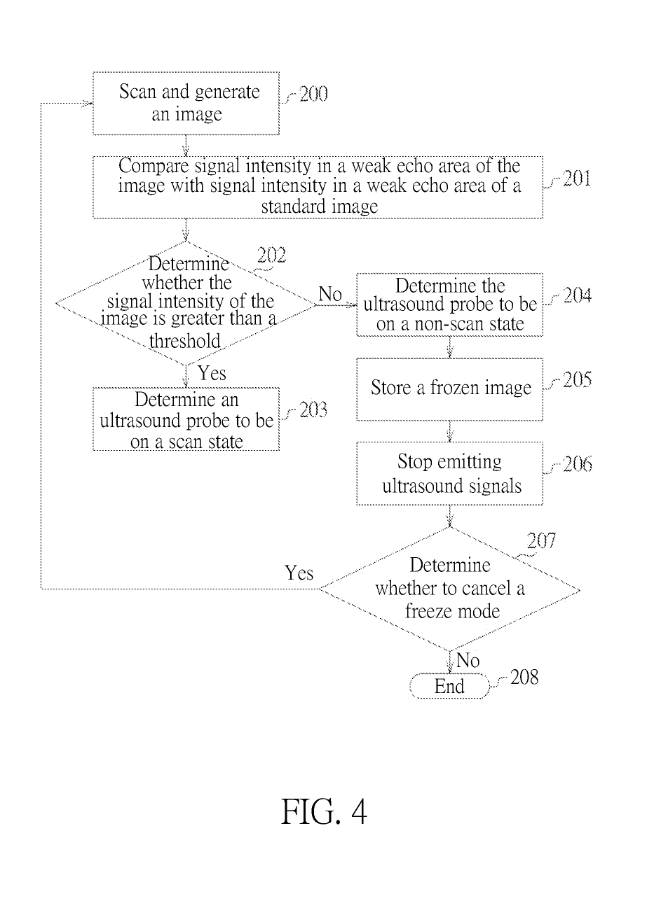

Please refer to FIG. 1 to FIG. 3. FIG. 1 is a diagram of a standard image Ig generated by an ultrasound probe and displayed on a user interface according to an embodiment of the present invention. FIG. 2 is a diagram of a signal intensity distribution of scan lines of the standard image Ig for generating a critical intensity value Tv according to the embodiment of the present invention. FIG. 3 is a diagram of dividing the standard image Ig into a strong echo area AH and a weak echo area AL by the critical intensity value Tv according to the embodiment of the present invention.

As shown in FIG. 1, after an ultrasound scanner is turned on to emit ultrasound signals, the ultrasound probe can receive an echo signals for generating the standard image Ig. According to the embodiment, the standard image Ig may not be regenerated every time the ultrasound scanner is turned on, and the standard image Ig may be generated once and saved as an image file for the following comparison of detection.

Please refer to FIG. 2, signal intensity values of the scan lines of the standard image Ig are averaged to calculate signal intensity average values corresponding to different depths according to the signal intensity distribution of the scan lines of the standard image Ig. And then, the signal intensity average values corresponding to the different depths can be statistically analyzed to generate the critical intensity value Tv for roughly dividing the standard image Ig into the strong echo area AH and the weak echo area AL. Thus, whether the ultrasound probe is on the scan state can be determined according to the critical intensity value Tv.

According to one embodiment, the critical intensity value Tv can be determined as a signal intensity value with a greatest number of signals among all the signal intensity values. For example, as shown in FIG. 2, the signal intensity value with the greatest number of signals is 110, so that the critical intensity value Tv is set to 110. As shown in FIG. 3, after the critical intensity value Tv is calculated, a boundary between the strong echo area AH and the weak echo area AL of the standard image Ig can be determined to be a first peak value lower than the critical intensity value Tv, so that the standard image Ig can be divided into the strong echo area AH and the weak echo area AL.

Please refer to FIG. 4. FIG. 4 is a flow chart for determining whether the ultrasound probe is on a scan state or on a non-scan state according to the embodiment of the present invention. The method includes the following steps:

Step 200: Scan and generate the image Sg by the ultrasound probe and dividing the image Sg into a strong echo area AH and a weak echo area AL.

Step 201: Compare signal intensity in the weak echo area AL of the image Sg with the signal intensity in the weak echo area AL of the standard image Ig.

Step 202: Determine whether the signal intensity in the weak echo area AL of the image Sg is greater than a threshold. If yes, go to step 203; if no, go to step 204.

Step 203: Determine the ultrasound probe to be on the scan state as the signal intensity in the weak echo area AL of the image Sg is greater than the threshold.

Step 204: Determine the ultrasound probe to be on the non-scan state as the signal intensity in the weak echo area AL of the image Sg is less than the threshold.

Step 205: The ultrasound probe enters a freeze mode so as to store a frozen image at a time before entering the freeze mode, as determining the ultrasound probe to be on the non-scan state for a predetermined period.

Step 206: Stop the ultrasound probe from emitting ultrasound signals.

Step 207: Determine whether to cancel the freeze mode as the ultrasound probe stops emitting ultrasound signals. If no, go to step 208; if yes, go to step 200.

Step 208: End.

For example, in step 202, the threshold can be set 1.5 to 2 times of the critical intensity value Tv. For another example, determining whether the signal intensity in the weak echo area AL of the image Sg is greater than the threshold can further include detecting an edge intensity of the weak echo area AL in an edge detection manner to generate the signal intensity in the weak echo area AL of the image Sg. If the edge intensity of the weak echo area AL of the image Sg is much greater than the edge intensity of the weak echo area AL of the standard image Ig, the ultrasound probe is determined to be on the scan state; if not, the ultrasound probe is determined to be on the non-scan state.

For another example, in step 202, determining whether the signal intensity in the weak echo area AL of the image Sg is greater than the threshold can include calculating signal intensity average values corresponding to the different depths in the weak echo area AL of the image Sg generated by the ultrasound probe. As a percentage of the signal intensity average values corresponding to the different depths in the weak echo area AL of the image Sg and exceeding the critical intensity value Tv exceeds a predetermined ratio (for example, more than 95%), the ultrasound probe is determined to be on the scan state. On the contrary, as a percentage of the signal intensity average values corresponding to the different depths in the weak echo area AL of the image Sg and being lower than or equal to the critical intensity value Tv exceeds a predetermined ratio (for example, more than 95%), the ultrasound probe is determined to be on the non-scan state. In this embodiment, step 201 can be omitted herein.

For another example, the signal intensity average values corresponding to the different depths in the weak echo area can be weighted for the judgment. First, average differences between signal intensity average values corresponding to the different depths of the image Sg and the standard image Ig are calculated. Then, the average differences are multiplied by different weights corresponding to the different depths to generate weighted average differences. For instance, the weight is proportional to the depth, that is, a weight corresponding to a deeper depth is greater than a weight corresponding to a shallower depth. At last, the ultrasound probe is determined to be on the scan state as a percentage of the weighted average differences corresponding to the different depths in the weak echo area AL and exceeding the threshold exceeds the predetermined ratio (for example, more than 95%).

In addition, in step 207, when the ultrasound probe stops emitting ultrasound signals, an alarm signal can be generated to notify a user whether to cancel the freeze mode. If no, the freeze mode can be maintained. If yes, the freeze mode can be canceled, and then the ultrasound probe emits ultrasound signals and restarts to scan. For another example, the freeze mode of the ultrasound probe can be canceled periodically, and steps 200 to 204 can be repeated to determine whether to enter the freeze mode again or restart to scan by ultrasound signals.

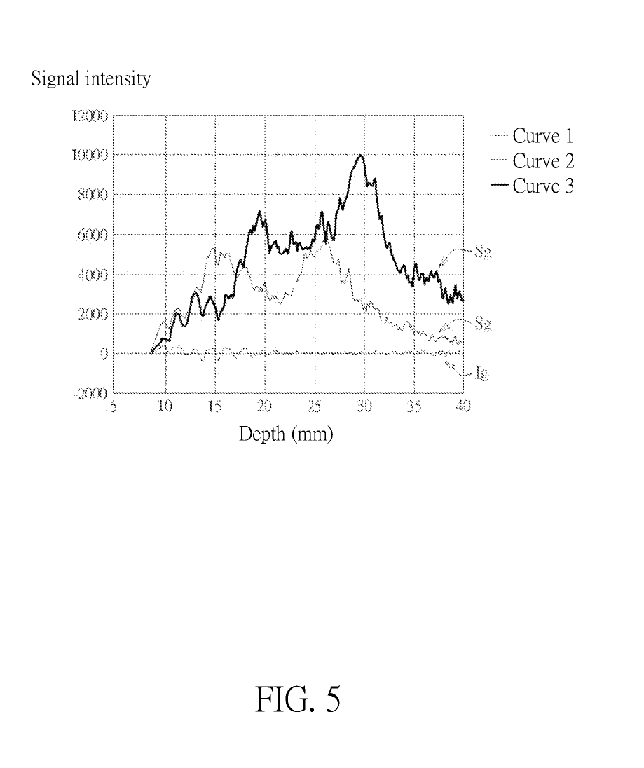

Please refer to FIG. 5. FIG. 5 is a diagram of signal intensity average values corresponding to the different depths of the image Sg and the standard image Ig in different conditions according to the embodiment of the present invention. As shown in FIG. 5, the signal intensity average values corresponding to the different depths of the standard image Ig generated by the ultrasound probe coated with a gel is illustrated as Curve 1. The signal intensity average values corresponding to the different depths of the image Sg generated by the ultrasound probe without coated gel is illustrated as Curve 2. The signal intensity average values corresponding to the different depths of the image Sg generated by the ultrasound probe coated with the gel is illustrated as Curve 3. According to the embodiment, the present invention provides the method including calculating average differences between signal intensity average values corresponding to the different depths of the image Sg and the standard image Ig, that is, the average differences between Curve 1 and Curve 2 or the average differences between Curve 1 and Curve 3, and then multiplying the average differences by weights corresponding to the different depths to generate the weighted average differences. It should be noticed that the thresholds can be 1.5 times to the signal intensity average values corresponding to the different depths of the standard image Ig. Once the weighted average differences corresponding to the different depths exceed the corresponding thresholds, the ultrasound probe is determined to be on the scan state. On the contrary, if the weighted average differences corresponding to the different depths do not exceed the corresponding thresholds, the ultrasound probe is determined to be on the non-scan state.

In contrast to the prior art, the method of the present invention includes determining whether the ultrasound probe is on the scan state or on the non-scan state. If the ultrasound probe is on the non-scan state and not in use for a long period, the ultrasound probe can enter the freeze mode and stop emitting ultrasound signals, so as to save power and reduce wear of the ultrasound probe. Furthermore, the freeze mode of the ultrasound probe can be canceled for restarting to scan.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for determining whether an ultrasound probe is on a scan state or on a non-scan state, the method comprising:
scanning and generating an image by an ultrasound probe;
dividing the image into a strong echo area and a weak echo area;
determining the ultrasound probe to be on the scan state as a signal intensity in the weak echo area of the image is greater than a threshold; and
determining the ultrasound probe to be on the non-scan state as the signal intensity in the weak echo area of the image is less than the threshold, and the ultrasound probe entering a freeze mode to store a frozen image at a time before entering the freeze mode.

2. The method of claim 1, further comprising:
scanning and generating a standard image by the ultrasound probe;
calculating signal intensity average values corresponding to different depths according to a signal intensity distribution of scan lines of the standard image;
analyzing the signal intensity average values corresponding to the different depths statistically to generate a critical intensity value for dividing the standard image into a strong echo area and a weak echo area; and
determining whether the ultrasound probe is on the scan state according to the critical intensity value.

3. The method of claim 2, further comprising:
calculating signal intensity average values corresponding to different depths in the weak echo area of the image generated by the ultrasound probe; and
determining the ultrasound probe to be on the scan state as a percentage of the signal intensity average values corresponding to the different depths in the weak echo area of the image and exceeding the critical intensity value exceeds a predetermined ratio, and determining the ultrasound probe to be on the non-scan state as all the signal intensity average values corresponding to the different depths in the weak echo area of the image are lower or equal to the critical intensity value.

4. The method of claim 2, further comprising:
determining a boundary between the strong echo area and the weak echo area of the standard image is a first peak value lower than the critical intensity value.

5. The method of claim 3, wherein the step calculating the signal intensity average values corresponding to the different depths in the weak echo area of the image generated by the ultrasound probe further comprises:
calculating average differences between signal intensity average values corresponding to the different depths in the weak echo area of the image and the standard image;
multiplying the average differences by weights corresponding to the different depths in the weak echo area to generate weighted average differences; and
determining the ultrasound probe to be on the scan state as a percentage of the weighted average differences corresponding to the different depths in the weak echo area and exceeding the threshold exceeds the predetermined ratio.

6. The method of claim 2, wherein the threshold is 1.5 to 2 times of the critical intensity value.

7. The method of claim 1, further comprising storing the frozen image and stopping the ultrasound probe from emitting ultrasound signals as determining the ultrasound probe to be on the non-scanned status for a predetermined period.

8. The method of claim 1, further comprising detecting an edge intensity of the weak echo area in an edge detection manner to generate the signal intensity in the weak echo area of the image.

9. The method of claim 1, further comprising:
canceling the freeze mode and restarting to scan and generate a new image.

10. The method of claim 1, further comprising:
canceling the freeze mode and restarting to scan and generate a new image then determining whether the ultrasound probe enters the freeze mode periodically.

11. A method of saving power of an ultrasound probe, the method comprising:
scanning and generating an image by ultrasound signals emitted from the ultrasound probe;
dividing the image into a strong echo area and a weak echo area; and
stopping the ultrasound probe from emitting ultrasound signals as the signal intensity in the weak echo area of the image is less than a threshold for a predetermined period.

12. The method of claim 11, further comprising:
scanning and generating a standard image by the ultrasound probe;
calculating signal intensity average values corresponding to different depths according to a signal intensity distribution of scan lines of the standard image; and
analyzing the signal intensity average values corresponding to the different depths to generate a critical intensity value for dividing the standard image into a strong echo area and a weak echo area.

13. The method of claim 12, further comprising:
calculating signal intensity average values corresponding to different depths in the weak echo area of the image generated by the ultrasound probe; and
determining the ultrasound probe to be on the scan state as a percentage of the signal intensity average values corresponding to different depths in the weak echo area of the image and exceeding the critical intensity value exceeds a predetermined ratio, and determining the ultrasound probe to be on the non-scan state as the signal intensity average values corresponding to the different depths in the weak echo area of the image are lower or equal to the critical intensity value.

14. The method of claim 12, further comprising:
determining a boundary between the strong echo area and the weak echo area of the standard image is a first peak value lower than the critical intensity value.

15. The method of claim 13, wherein the step calculating the signal intensity average values corresponding to the different depths in the weak echo area of the image further comprises:
calculating average differences between signal intensity average values corresponding to the different depths in the weak echo area of the image and the standard image;
multiplying the average differences by weights corresponding to the different depths in the weak echo area to generate weighted average differences; and
determining the ultrasound probe to be on the scan state as a percentage of the weighted average difference corresponding to the different depths in the weak echo area and exceeding the threshold exceeds the predetermined ratio.

16. The method of claim 12, wherein the threshold is 1.5 to 2 times of the critical intensity value.

17. The method of claim 11, further comprising entering a freeze mode so as to store the frozen image at a time before entering the freeze mode as the signal intensity in the weak echo area of the image is less than the threshold for the predetermined period.

18. The method of claim 17, further comprising sending an alarm signal for selectively canceling the freeze mode as the ultrasound probe stops emitting ultrasound signals.

19. The method of claim 17, further comprising canceling the freeze mode of the ultrasound probe periodically.

20. The method of claim 12, further comprising generating a new standard image by the ultrasound probe when restarting the ultrasound probe.
